(19) United States
(12) Patent Application Publication
(10) Pub. No.: US 2010/0048244 A1
(43) Pub. Date: Feb. 25, 2010

(54) VEHICLE REMOTE CONTROL SYSTEM WITH ADJUSTABLE REPLACEMENT DEVICE

(76) Inventor: Nir Goren, Ramat Gun (IL)

Correspondence Address: ARENT FOX LLP, 1050 CONNECTICUT AVENUE, N.W., SUITE 400, WASHINGTON, DC, 20036, US

(21) Appl. No.: 12/441,597

(22) PCT Filed: Sep. 23, 2007
(86) PCT No.: PCT/IL2007/001171

§ 371 Date: Mar. 17, 2009

Related U.S. Application Data
(60) Provisional application No. 60/846,112, filed on Sep. 21, 2006.

(51) Int. Cl. H04M 1/00; G08C 19/00; H04B 7/00

(52) U.S. Cl. 455/556.2; 340/825.69; 455/41.2; 455/556.1

(57) ABSTRACT

An efficient vehicle remote control system for controlling vehicle sub-systems, devices and accessories. The system includes a connector device (110) connected to the vehicle central computer through a vehicle bus such as CAN bus. The system further includes remote control device (109, 111, 112) communicating with the connector device, through which various accessories installed in the vehicle are operatively controlled.

### FIELD OF THE INVENTION

The present invention relates to vehicle remote control systems and in particular, the present invention relates to a special connector device adapted to permit a quick replacement of vehicle control systems and a multifunctional remote control integrated in the car key or is operating via a mobile phone.

### BACKGROUND OF THE INVENTION

Vehicle security and comfort systems are widely used in vehicles and perform various security and comfort related vehicle functions. A typical vehicle security system includes a controller having a receiver connected thereto. The controller may perform security-related functions, such as locking/unlocking doors, or switching between armed and disarmed modes of a car alarm, hook up system controlling engine function, remote control hook up, responsive to signals received from one or more remote transmitters. When in the armed mode, the controller may generate an alarm indication responsive to a vehicle security sensor indicating a vehicle security breach. As for comfort-related vehicle functions, such as turning on/off accessories, turning on/off lights, mobile-phones or entertainment accessories, responsive to signals received from one or more remote transmitters. Every new car is equipped with at least 2-3 security and comfort related vehicle accessories that need at least 4 working hours for installation. Each of the above security and comfort related vehicle accessories is responsive to signals received from one or more different non related remote transmitters manufactured by different manufactures.

When any of the above security and comfort related vehicle accessories malfunctions, it takes quite some time to find the malfunctioned device, repair or replace it.

There is no way to avoid the long installation or repair time nor the damage to the vehicle by opening original covers and replacing wires etc. There is no single system that is compatible with all security and comfort related vehicle accessories.

### SUMMARY OF THE INVENTION

The principal intentions of the present invention include providing an efficient and more convenient vehicle remote control system which is compatible with all security and comfort related vehicle accessories, which saves time and money in original installation, repair and replacement processes.

According to the teachings of the present invention there is provided a remote control system including an RF receiver controlled by an RF remote control transmitter. The remote control system is capable of sending various commands by the transmitter that transmits electrical pulses to the system and from it to the vehicle central computer or to relevant electrical systems in the vehicle. The remote transmitter is using RF frequency located in the car key or in a mobile phone preferably equipped with a Bluetooth (BT) transmitter, and a hands free telephone having a BT build-in, to operate the system through a connector device. The connector device uses RF waves in changeable frequency and is an adjustable plug & play unit, attached to wires braid connected to the vehicle central computer at one end, and to wires braid of the unit at the other end. The multifunctional remote control is integrated in the car key or is operating via a mobile phone. The functions of the multifunctional remote control device include, as hereunder described, a code security system that electronically disconnects the vehicle functions when a security breach is detected. The multifunctional remote control replaces the code security system located in the vehicle.

The system may perform security-related functions, such as locking/unlocking doors, unlocking the trunk, switching one or more alarm systems between armed and disarmed modes and turning on/off a theft alert siren, turning on/off lights, comfort-related functions, such as turning on/off entertainment accessories, operate a mobile phone and operating other accessories, responsive to signals received from the remote transmitters. The system of the present invention enables the installation of the aforesaid accessories without the need to cut any wires within the vehicle and therefore, the system of the present invention is more reliable, more efficient and safer than any prior art system executing the above functions.

If any of the vehicle functions, controlled by the system, malfunctions, the system can be replaced by mere replacement of the connector device, a work which takes minutes and saves a lot of time and money.

The connector device is a plug & play unit, comprising, as many OEM entrances or the vehicle central computer or plug adapters as desired according to the different functions to be performed by the remote control transmitters; RF unit; internal and/or external antennas; a link to BT build-in hands free telephone; several plugs for example, but not limited to, alarm system and ultra sonic space detector, etc.

### DESCRIPTION OF THE DRAWINGS

The present invention will become fully understood from the detailed description given herein below and the accompanying drawings, which are given by way of illustrations and examples only and thus not limitative of the present invention.

FIG. 1 shows a schematic view of the adjustable connector of a remote control system according to embodiments of the present invention.

FIG. 2 shows a schematic view of the multifunctional remote control device integrated in a car key according to one embodiment of the present invention.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

By way of introduction, the principal intentions of the present invention include providing an efficient and more convenient vehicle remote control system which is compatible with all security and comfort related vehicle accessories, which saves time and money in original installation, repair and replacement processes. The system includes a connector device connected to the vehicle central computer through a vehicle bus such as CAN bus. The system further includes remote control device communicating with the connector device, through which various accessories installed in the vehicle are operatively controlled.

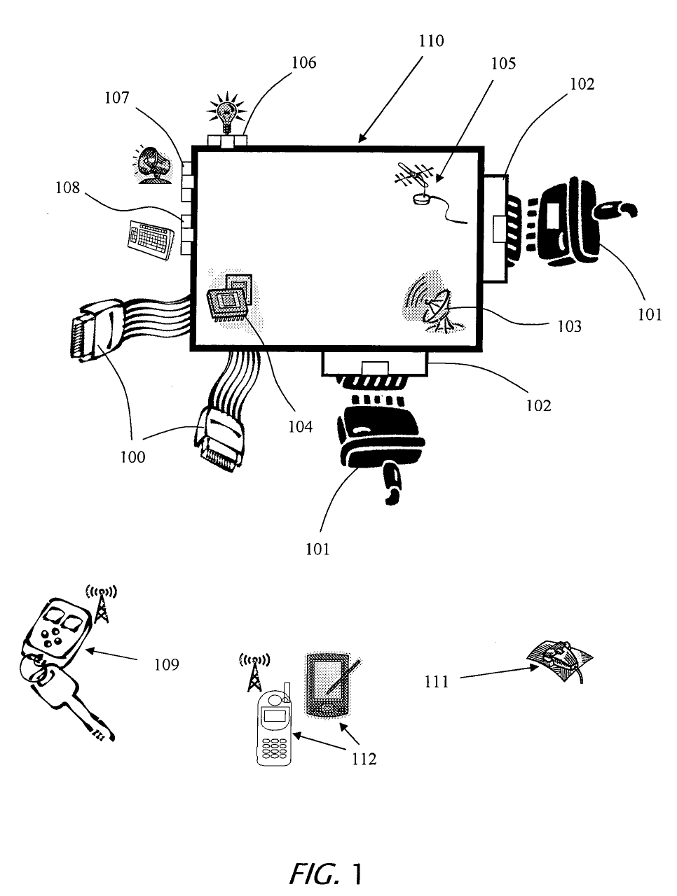

Reference is now made to the drawings. FIG. 1 shows a schematic view of the adjustable connector (110) of a remote control system according to embodiments of the present invention.

The connector device (110) uses RF waves in changeable frequency and is an adjustable plug & play unit connected to the vehicle central computer through a vehicle bus such as CAN bus. Connector device 110 further includes connectors to connect to the vehicle power. Connector device 110 may include various standard connectors (100, 101, 102), such as wires braid, flat cables male/female connector and/or any other standard connector.

Connector device 110 may include an antenna unit 105 for increasing the intensity of receiver 103 of an electronic surveillance unit 104. Connector device 110 may optionally include connectors to directly connect to devices as desired, for example: a fid back indication plug (106), an alert siren plug (107), a plug for keyboard 108, controlling one or more coded detachment units (111).

Unit 111 is a remote control hook up RF receiver, controlled by keyboard 108, for detaching the ignition systems of the vehicle, like fuel, starter, computer original immobilizer etc.

The multifunctional remote control (109 or 112) replaces the code security system located in the vehicle. The system includes an RF receiver (103) controlled by an RF remote control transmitter (109 or 112). The remote control (109 or 112) is capable of transmitting various commands to receiver (103) that transmits electrical pulses to the electronic surveillance unit (104) functioning as a system data brain with suitable software that performs the received instructions by directing the orders to the vehicle central computer or directly to relevant electrical systems in the vehicle like, for example but not limited to, security-related functions, such as locking/unlocking doors, unlocking the trunk, switching one or more alarm systems between armed and disarmed modes and turning on/off a theft alert siren 107, turning on/off lights, comfort-related functions, such as turning on/off entertainment accessories, operate a mobile phone and operating other accessories, responsive to signals received from the remote transmitters.

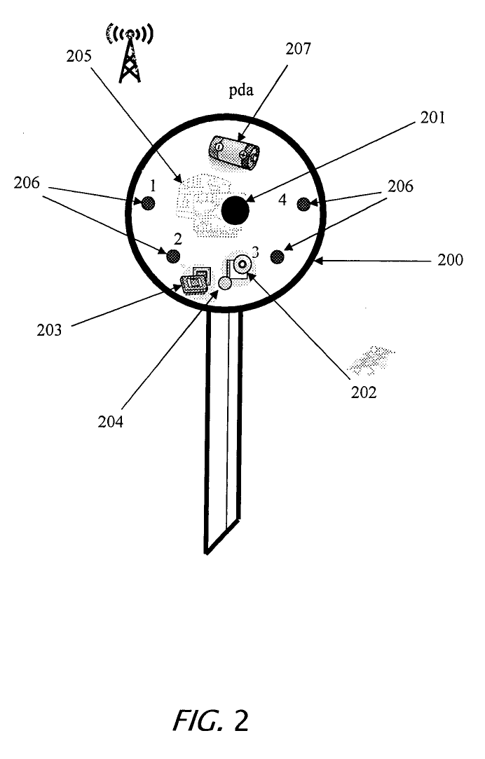

Reference is also made to FIG. 2, which shows a schematic view of the multifunctional remote control device integrated in a car key 200 according to embodiments of the present invention. Car key 200 preferably comprises a pin code security system that electronically disconnects the vehicle functions when a security breach is detected. Car key 200 comprises an OK switch 201, a detachment and disruption of the vehicle original immobilizer unit (202) that controls transponder 203, a fid back indication unit 204 that, for example, blinks to confirm the correct pin code entry, RF transmitter unit 205 generally located at the center of car key 200 and used as a remote control to the plug & play alarm system, numbered keys 206 for pin code number entry that disrupts the transponder (203) function for preventing communication between car key 200 and the vehicle central computer.

Yet another embodiment of the present invention is to use a mobile device (112), such as a mobile phone, a PDA, Pocket PC or devices the like, equipped with a Bluetooth transmitter and a hands free telephone, having a BT build-in, to operate the system through the connector device. It should be noted that a given mobile device 112 is securely connected to the remote control system, according to the present invention.

The remote control with the plug & play alarm system are the most advanced and efficient protection against unauthorized use of a vehicle. Even if the car key is in the possession of an unauthorized individual, it is useless unless the security code is revealed.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the following claims.

1. A control device for controlling vehicle and sub-systems, devices and accessories comprising:
(a) a connector device capable of connecting to the vehicle central computer;
(b) a multifunctional remote control device capable of communicating with said connector device, and
(c) a wireless communication device.

2. The device of claim 1, wherein said connector device is capable of reading information from selected vehicle devices, connected to the vehicle central computer.

3. The device of claim 1, wherein said connector device is capable of writing information to selected vehicle devices connected to the vehicle central computer.

4. The device claim 2, wherein said selected vehicle devices are selected from the group of devices including security-related functions, such as locking/unlocking doors, unlocking the trunk, switching one or more alarm systems between armed and disarmed modes and turning on/off a theft alert siren, turning on/off lights, comfort-related functions, such as turning on/off entertainment accessories, operate a mobile phone and operating other accessories.

5. The device of claim 3, wherein said selected vehicle devices are selected from the group of devices including security-related functions, such as locking/unlocking doors, unlocking the trunk, switching one or more alarm systems between armed and disarmed modes and turning on/off a theft alert siren, turning on/off lights, comfort-related functions, such as turning on/off entertainment accessories, operate a mobile phone and operating other accessories.

6. The device of claim 1, wherein said connector device is directly connected to an in-vehicle device, thereby said in-vehicle device can be operatively controlled.

7. The device of claim 1, wherein said multifunctional remote control device communicates with said connector devices utilizing said wireless communication device to operatively control a selected vehicle sub-system device or accessory.

8. The device of claim 1, wherein said wireless communication device, is Bluetooth.

9. The device of claim 1, wherein said multifunctional remote control device comprises a transmitter wherein said transmitter is part of said wireless communication device.

10. The device of claim 8, wherein said multifunctional remote control device is a mobile device selected from a group of mobile devices including a mobile phone, a PDA, a Pocket PC.

11. The device of claim 1, wherein said multifunctional remote control device, is integrated into the vehicle ignition key.

12. The device of claim 1, wherein said multifunctional remote control device, comprises a pin code security system.

13. In a vehicle having a control device for controlling vehicle and sub-systems, devices and accessories, as in claim 1, a method comprising the steps of:
(a) connecting a connector device to the vehicle central computer;
(b) operating a multifunctional remote control device to communicating with said connector device thereby communicating with selected vehicle devices, connected to the vehicle central computer, wherein said multifunctional remote control device communicates with said connector devices utilizing a wireless communication device.

14. The device of claim 13, wherein said wireless communication device, is Bluetooth.
